(19) United States
(12) Patent Application Publication
(10) Pub. No.: US 2014/0062720 A1
(43) Pub. Date: Mar. 6, 2014

(54) Remote Pipeline Corrosion Protection and Valve Monitoring Apparatus

(71) Applicants: John Murray Spruth, Houston, TX (US); Daniel Jay Schacht, Houston, TX (US)

(72) Inventors: John Murray Spruth, Houston, TX (US); Daniel Jay Schacht, Houston, TX (US)

(21) Appl. No.: 13/605,163

(22) Filed: Sep. 6, 2012

(51) Int. Cl. G08C 15/06

(52) U.S. Cl. 340/870.02

(57) ABSTRACT

A combined method and apparatus for the detection, monitoring and control of electrolytic corrosion in pipelines and other metallic structures along with pipeline valve status and pressure changes indicating a loss of flammable or toxic high pressure products. Pipeline valve station and corrosion protection station status is monitored and controlled from a distant location. The apparatus transmits data by electrical signal along the conductive pipe or by short-range and long-range radio transceivers.

Reference is made to U.S. Pat. No. 8,248,088.

### BACKGROUND OF THE INVENTION

High pressure gas and fluid transmission pipelines are fraught with danger if not properly tended and monitored. At given distances along the pipeline, valves are placed to interrupt the flow of product within the pipe. These valves are important in isolating flammable or explosive products upon any breach in the integrity of the pipe. These valves are visually inspected and controlled on site by trained personnel.

Additionally, a protective DC source, known to the art as a rectifier, has a transformer and diode bridge to provide a DC corrosion protective voltage of negative polarity to a metal structure such as a pipeline. Although the pipe is coated with external insulation, breaches or ‘holidays’ in the insulation serve as areas for metallic corrosion and potential pipeline failure. This erosion of the exposed metal is also known as electrolytic corrosion. At distance intervals of 1 to 3 miles buried along the pipeline, active coupons made from the same alloy as the pipeline are attached through a surface junction box to the pipe metal with insulated wire. These active coupons act as surrogates for pipe holidays. Depending upon soil conditions, an active coupon would corrode without the protective DC source. Electrical measurements are taken at each junction box by walking the line with a hand-held meter or data-recording device. This is a labor-intensive and sometimes hazardous task to collect data on a pipeline. A hand-held apparatus to remotely measure the protective voltage is manually carried to each surface junction box to report the condition at each distant point to alert the operator of the DC protective source to raise or lower the rectifier voltage accordingly.

### OUTLINE OF THE INVENTION

The apparatus described herein, a remote pipeline valve monitor (RPVM), automatically reads the status and controls the operation of inline pipeline valves, including valve position and upstream and downstream pressure and the time rate of change in pressures. A change in the differential upstream and downstream pressure can indicate a leak or rupture of a pipeline and the release of highly flammable or explosive product.

In embodiments of the invention, a rectifier impresses a DC voltage on a pipeline to offset any corrosive action at breaches in the pipeline insulation. A modulating signal is periodically superimposed upon this DC voltage and transmitted along the metallic portion of the pipe. A few watts of signal energy will travel several miles using frequencies in the approximate range of 2 kHz to 40 kHz or higher. A Base Control Unit [B CU] comprised of a microcontroller unit [MCU] generates the modulated signal for a series of remote control units [RCU] located along the pipe. Each RCU has a unique signal address. At the request of the BCU the selected RCU transmits data gathered at the remote site and is returned along the same metallic pipe. Each signal has a unique identifier, address, and transmission timing method to prevent data corruption or collision.

Additionally, the apparatus herein described removes the need to walk the pipeline to obtain timely and relevant data on the corrosion protection applied to the pipe. This apparatus is referred to here as a Remote Corrosion Protection Monitoring station, or RCPM, having a number of features to monitor each pipeline inspection site without the need for the physical presence of field personnel. At each inspection site, located at periodic distances, a self-powered data module will monitor a number of electrical parameters of interest to the corrosion protection industry. These values include but are not limited to the DC potential between the active coupon and a reference electrode, the DC decay potential upon temporarily disconnecting the active coupon from the pipe, the AC potential between the reference electrode and the active coupon under the connected and disconnected conditions, the DC and AC currents flowing between the active coupon and the reference electrode, and stray electrical fields induced on the pipeline by nearby power transmission systems, electrical rail systems, other nearby pipelines, etc. Automatic measurements of the potential on a native coupon that is not connected to the pipe are also taken. Other structures are understood to be protected by the same apparatus, including steel buildings, bridges, steel rod reinforced concrete structures, metal tanks, and the like.

In one embodiment the valve monitor apparatus includes pressure sensors to read both upstream and downstream pressures on each side of a valve assembly, solenoid control of the valve position, and the opened or closed valve position as determined by limit switches. A valve angle position monitor indicates the angular position of the valve between limits can be included. The valve monitor apparatus controls the valve position under remote command.

Periodically, in each RPVM and RCPM, a microprocessor unit (MPU) awakens and reads all desired values into storage memory. These values are then transmitted by a directly wired data transmission transceiver or a wireless short-range transceiver (SRT) to a nearby remote station or to a more distant data reception point by means of a cellular service transceiver (CST) or orbiting satellite transceiver (OST).

A number of RPVMs and RCPMs distributed along the length of the pipeline are in communication with and will relay the data of each station to the next station. Every few stations, a base station, having either a wireless SRT or a wired direct electrical data transmission transceiver (or both) transfers the data with a CST to relay the data to a cellular tower transceiver and a central data center. In remote regions, beyond cellular contact, the base station is equipped with an OST.

All the data transmission devices, whether wireless SRTs or directly wired data transmission stations, configure a data block into a short burst of information having a header containing a date and time stamp, a unit number, and digitally encoded measured values. This information is collected at a central office terminal COT. Encrypted virtual private networks (VPNs), i.e., Crossbridge™ Servers can isolate the data and command structures to protect the pipeline valve operation from any public internet criminal mischief.

The RPVMs and RCPMs allow unattended observation of protected structures, remote operation of the valves, and alarms to a distant station at a great cost savings.

While prior art impresses a carrier signal on a stretch of pipe for the purpose of pipe location with an externally held pipe location monitor, this differs in at least three key features. First, the carrier frequency is not modulated to carry any data along the pipe and is solely present to determine the maximum strength of signal over the exact location of the pipe otherwise invisible under the surface. And second, the hand held pipe location monitor is not directly electrically connected to the pipe, and therefore not able to determine a much weaker data modulated carrier signal at the required distances. Third, the hand held pipe location monitor cannot report valve and pressure information and corrosion protection status.

### OUTLINE OF THE DRAWINGS

FIG. 1 is a remote valve monitor and control unit in communication with a base control unit;

FIG. 2 is a remote corrosion prevention monitor unit in communication with a base control unit;

FIG. 3 is base control unit with communication modulator;

FIG. 4 is a long and short range communication array with pipeline safety determination local and long range data analysis;

FIG. 5 is a pipeline valve management software flowchart;

FIG. 6 details a return signaling means; and,

FIG. 7 details a remote power source to operate the remote communication signal modulator.

### DETAILS OF THE DRAWINGS

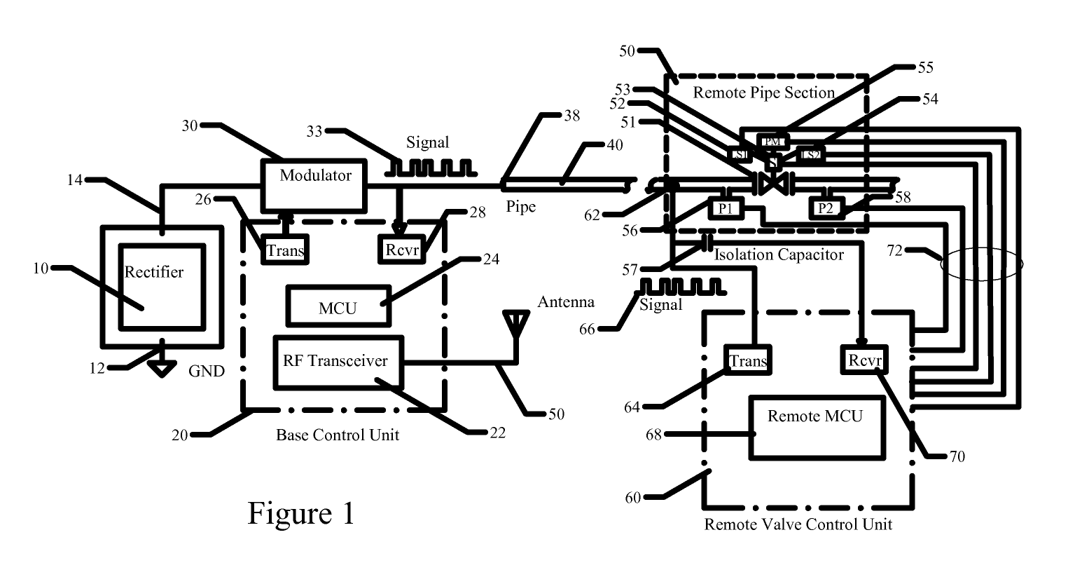

FIG. 1 shows a rectifier assembly 10 that provides a corrosion prevention DC bias to a pipeline or other metallic structure of sufficient voltage and current. Negative voltage 14 is connected through modulator 30 while positive lead 12 is connected to a buried ground anode. A base control unit (BCU) 20 is equipped with a microprocessor control unit (MCU) 24, a data transmitter 26 and a data receiver 28. The MCU is connected to a radio frequency transmitter and receiver (RF unit) 22 which can be of a short or a long-range nature, i.e., a master transceiver station, such as a cellular or a satellite transceiver. The RF unit is connected to an antenna 50.

Transmitter 26 periodically modulates a data communication signal 33 superimposed upon the corrosion prevention voltage. This signal is directly coupled by insulated wire to pipe or structure 40 at a bonding point 38. The pipe or structure is insulated with an non-conductive coating. The pipe or structure acts to transmit the modulated data communication signal to a remote valve control unit (RVCU) 60. The attenuated modulated signal 33 is connected to the RVCU with a direct metallic bond 62. The distance between the transmitter and receiver can be more that 20 miles, depending upon several electrical and mechanical conditions. For a give size of pipe and a given thickness of insulation, the pipe acts as an electrical capacitor, the one electrode being the pipe itself and the other being the earth in which the pipe is buried. A large diameter pipe with thin insulation buried in highly conductive earth would have the highest electrical capacitance per mile of length. Rule of thumb calculations for highly conductive soil and 4 thousands of an inch thickness thin film epoxy coating on a pipe 12 inches in diameter results in the need for a low frequency modulated signal of 2 kHz to 40 kHz range. Both the base unit and the remote units can adjust the communication frequency to the pipe electrical characteristics. A return data communication signal 66 is shown to emphasize the bidirectional nature of the data communication.

In FIG. 1, a remote pipe section 50 is equipped with an inline valve 51 having a position control actuator 53, a valve position monitor 55, an valve open limit switch 52 and a valve closed limit switch 54, all connected by wiring harness 72 to the RVCU 60. Upstream pressure monitor 56 and downstream pressure monitor 58 provide analog or encoded digital signals to the RVCU. Some pressure monitors are now equipped with wireless direct transmission to a nearby system monitor. This is anticipated in this embodiment of the invention. The remote valve control unit 60 has a microcontroller unit 68 in connected to a modulation transmitter 64 to send the data encoded on data communication signal 66. A receiver 70 reads the incoming data communication signal 33. It should be noted that the signal from transmitter 64 is of sufficient strength to be received by the base unit and by downstream remote units. The receiver is shown with an isolation capacitor 57 to pass only the signal, though this capacitor is optional in some embodiments.

Signals are sent bidirectionally (i.e., in both directions) between all stations on the line. Each station has a unique address. The periodic burst of data from each station indicates the station number, the date and time, the upstream and downstream pressures, the valve position, control commands, self-test MCU circuit status, data word parity checks and check-sums. Anti-collision protocols prevent attempts from several units to send data at the same time. The global positioning coordinates can be included in the unique unit address. All of the necessary control commands are heavily encrypted to prevent unauthorized tampering. At each station, a tamper-proof enclosure with tamper indication in the data transmission is anticipated by the inventors. Redundant circuitry to insure proper valve operation in an emergency is anticipated by the invention.

Though only one RVCU is shown, a number of similar units can be in communication using the metallic pipe structure to transmit and receive periodic data. RCVUs located a distance of several miles apart can relay status and command data through each other to read or control a unique site.

Often, a series of parallel valves located together in a manifold at a single location are monitored for similar pressure profiles. If any downstream pressure shows an abnormal rate of pressure drop (indicating a leak or breach), an alarm to a central system is sent. Automatic local valve closure and upstream compressor changes can be initiated.

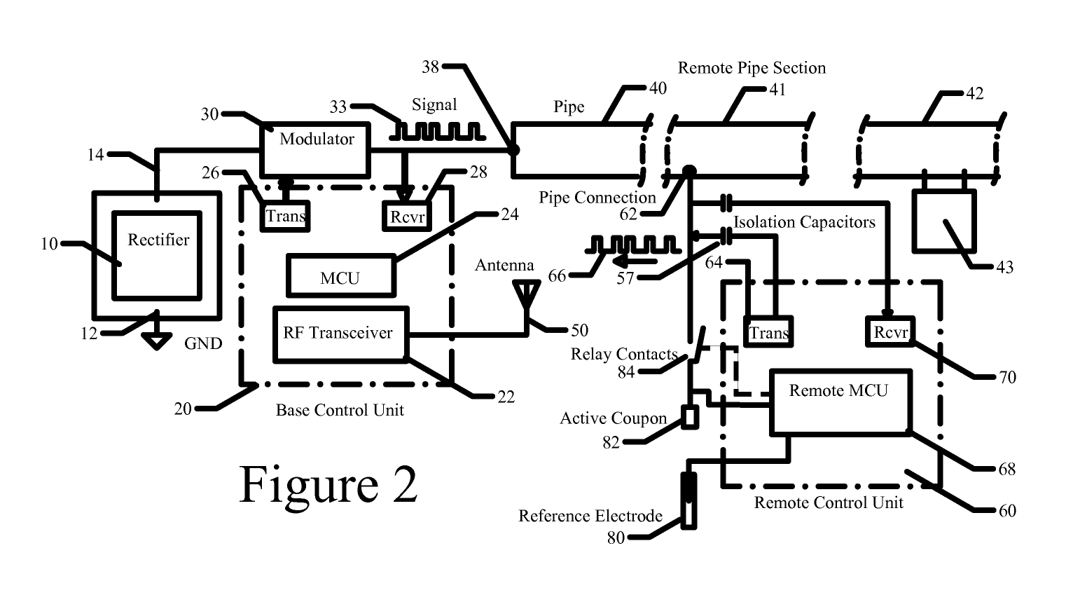

FIG. 2 details a rectifier assembly 10 having a negative dc voltage connected by conductor 14 through a modulator circuit 30 to an electrical bonding point 38 on a pipe or structure 40. A ground conductor 12 connects to a buried metallic anode in contact with the surrounding earth. A base control unit (B CU) 20 periodically transmits data to the modulator 30 to superimpose a stream of digital data on the rectifier voltage. Similar data from a remote control unit is connected from the pipe bond 38 to the receiver 28 in the BCU 20. The BCU has a microcontroller unit (MCU) 24 and a radio frequency transceiver 22 of a short or long-range nature, i.e., cellular or satellite radio transceiver. Antenna 50 is connected to the radio frequency transceiver.

The corrosion prevention remote control unit (RCPM) 60 is equipped with a reference electrode 80 buried below grade, a buried active coupon 82, a normally closed relay 84, a data transmitter and modulator 64 and a data receiver 70. Optional isolation capacitors 57 are shown. The coupon is attached by insulated wire to a bonding point 62 at a spot on a remote section of the pipe or structure 41. A downstream section of pipe 42 is shown with another RCPM or RCVU 43 attached.

The RCPM offers the following circuit features, comprising the ability to “zero out” the IR voltage drop between reference electrode and coupon, and to calculate the dropping resistance and coupon current; circuitry to separate out the AC rms voltage value, instantaneous or averaged over a time interval; circuitry to read and record the protective DC voltage component without the AC component; circuitry to record the AC waveform for several cycles; and circuitry to record DC at intervals to demonstrate DC voltage drift from stray currents.

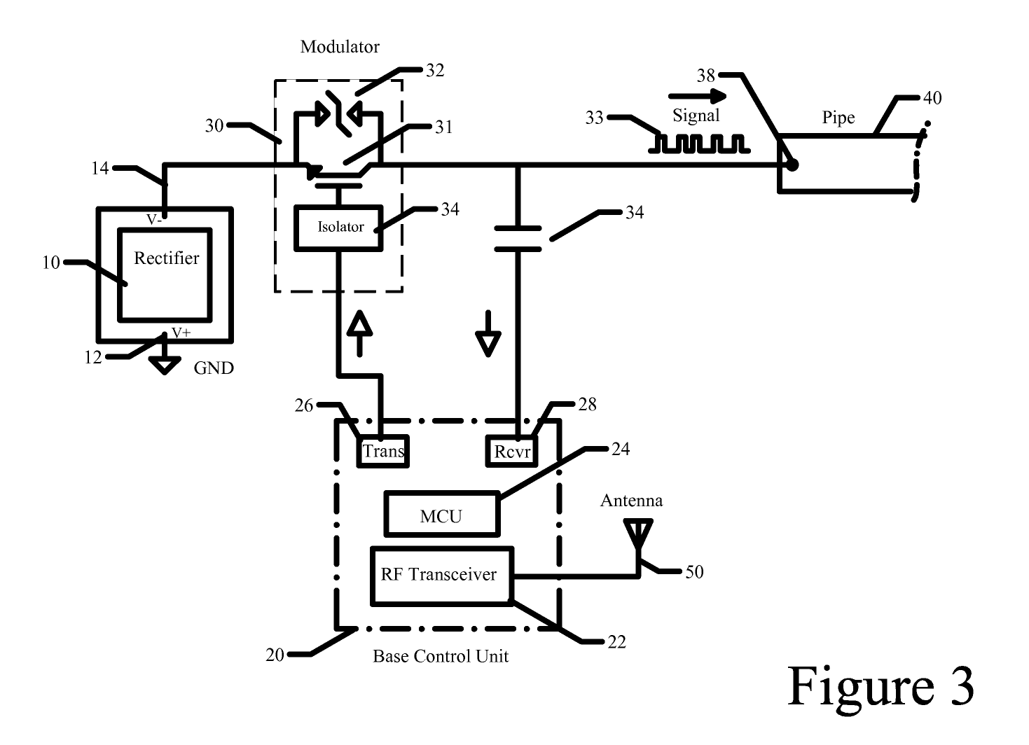

FIG. 3 details an embodiment of the modulator 30 with an insulated gate bipolar transistor (IGBT) 31 modulated by BCU 20 through an isolator 33. The preferred method is the use of an opto-isolator circuit 34 with several kilovolt isolation between the BCU transmitter 26 and the IGBT control gate terminal. The modulation signal drives the IGBT in and out of conduction, thereby superimposing a digital signal on the rectifier voltage. Power for the BCU and isolator 34 are derived from the rectifier assembly or solar refreshed rechargeable batteries. Lightning and surge protection device 32 is connected across the IGBT. A power metal oxide field effect transistor (MOSFET) can be substituted for the IGBT. Similarly, isolator 34 can be a transformer isolated circuit, know to the art. Additionally, the modulator power transistor can be used to adjust the level of voltage provided to the pipeline.

Digital communication signals received from the Remote control units are detected through optional capacitor 34 and receiver 28 to inform the MCU 24 of the status of the distant modules. A RF Transceiver 22 with antenna 50 communicates with a distant central data collection and control station.

The Base Control unit is capable of bidirectional communication with a number of distant Remote Control Units configured to read either Corrosion Protection data or Valve Status Data using the metallic pipe or structure as the transmitting media.

In other embodiments of the invention, wireless radio communication between the BCU and the remote control modules (the RCPMs and RCVUs) is anticipated. The same data can be transmitted bidirectionally using a number of Radio Frequency protocols, DCMA, SMS, back channel, etc.

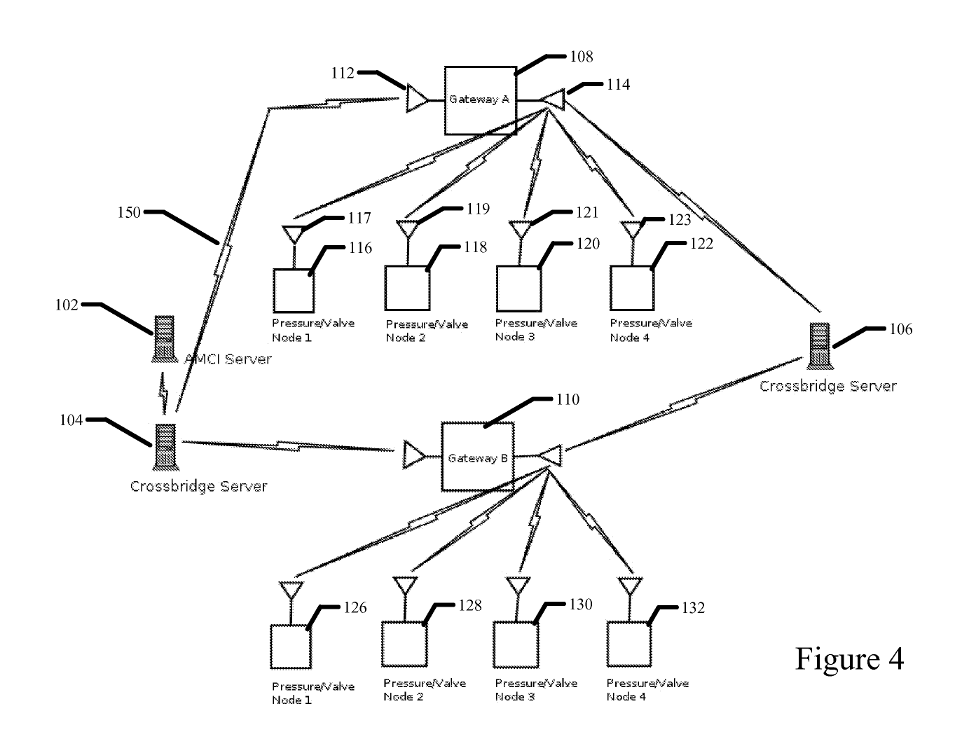

FIG. 4 illustrates one of several configurations using wireless transmission of localized groups of RVCUs 116, 118, 120 and 122 with respective antennas 117, 119, 121, and 123 in communication with a gateway transceiver 108 through its antenna 114. A similar array of RVCUs 126, 128, 130 and 132 with respective antennas communicate with gateway B 110. These arrays are in communication with an isolated set of Crossbridge™ Servers 104 and 106 to serve as a secure Virtual Private Network (VPN),i.e., Crossbridge™. Heavily encrypted data and commands are further communicated to a host server (i.e., AMCI) over the public internet to the central office terminal (COT).

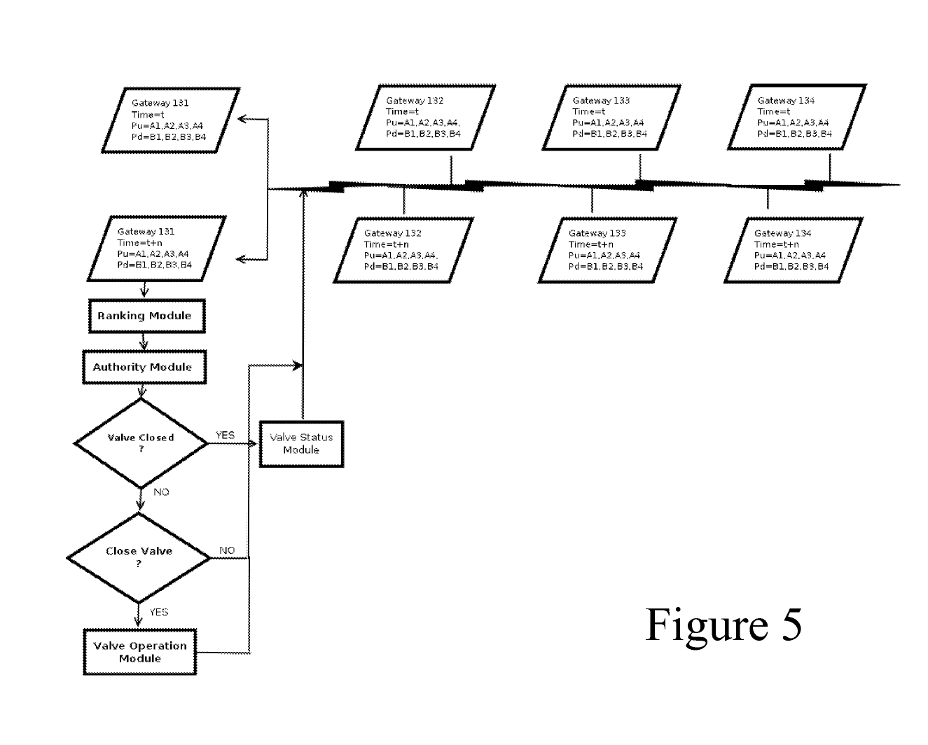

FIG. 5 details a software flowchart Ranking Module. The central gateway receives data including but not limited to pressure, date, time, temperature and GPS coordinates from short range RF modules and longer range cellular or satellite wireless modules located along the pipeline. Stored in the gateway's central processing unit (CPU) is a ranking module (RM) which is a computer program that accesses the data and calculates and stores certain parameters including but not limited to the pressure difference between pipelines at each time (t) and an earlier time interval (t−1). This time rate of change in differential pressure between pipelines recorded at each point along the pipeline gives the rate of pressure drop recorded at each point along the pipeline. The absolute pressure is also recorded at each point along the pipeline at time t. The ranking module RM then ranks the values based on several criteria:

the importance of the parameter(s) in predicting and/or indicating a pipeline break; proximity of location to a pipeline break if predicted or detected;
the consequence of a pipeline break related to location such as population density, proximity to residences and places people might congregate such as schools, entertainment venues, and hazardous or important infrastructure;
and, user define criteria such as pipeline age, repair history.

These parameters determine the level of alarm and the response called for.

A database maintains a list of prioritized sets of actions in response to a detected alarm by at least one remote corrosion protection monitor [RCPM] and at least one remote pipeline valve monitor [RPVM]. The remote network and the central office terminal [COT] can notify the proper authorities to evacuate a given danger zone or send a maintenance crew as required.

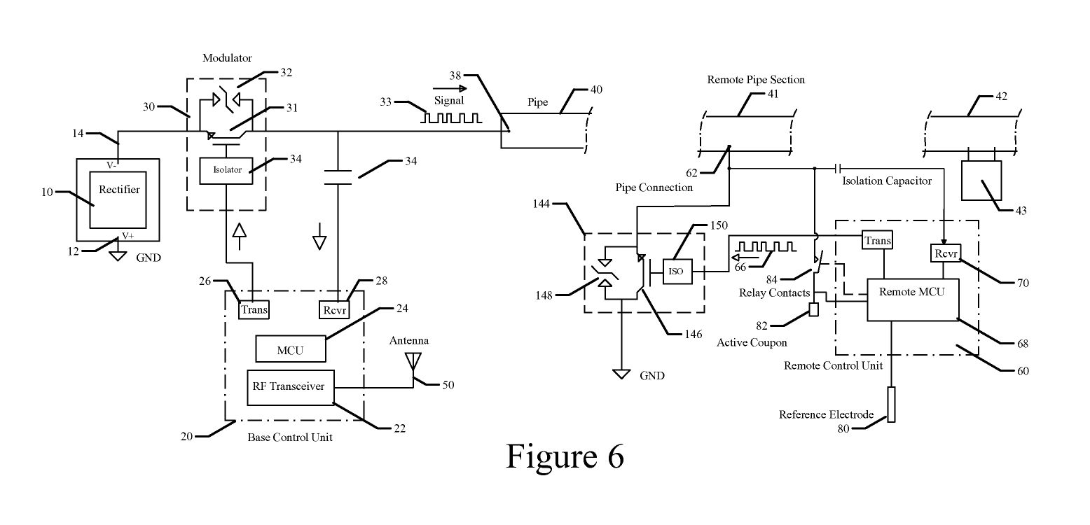

FIG. 6 illustrates the means by which the remote control unit 60 modulates a return signal 66 through the conductive pipe or structure from remote pipe section 41 to the pipe section 40 wired to the base control unit 20. A remote or distant communication modulator 144 [DCM] is normally in a high resistance, non-conductive state with IGBT 146 not conducting current to ground. When a digital communication signal 66 is applied through isolator 150 to the gate of the IGBT, the rectifier current from rectifier assemble 10 is remotely pulled toward ground, superimposing a communication signal voltage and current change on the pipe structure. This communication signal is detected by receiver 28 in the base control unit 20 and in additional remote units 43 wired to pipe structures 42. Pipe corrosion protection current is not compromised, since this signal is present infrequently and follows a protocol that prevents signal collisions between control units. Remote modulator 144 has a number of surge and lightning protection elements 148.

When the remote modulator 144 DCM is in the normal, non-conduction, high impedance state, and relay contacts 84 are is the normally closed state, the active coupon 82 acts as if no circuitry is present. Periodic measurements are taken by the remote MCU 68 and the stored data values are transmitted to the remote modulator 144.

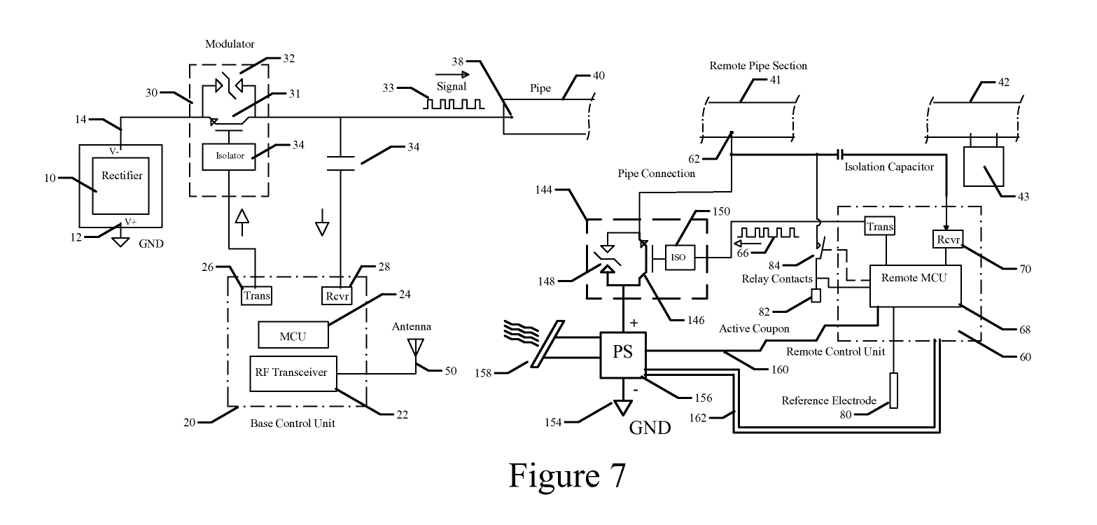

FIG. 7 details a remote dc power source 156 capable of providing the necessary current and voltage to independently supply the remote modulator 144. Rechargeable batteries and a battery management circuit are one embodiment of this power source. Solar panel 158 replenishes the energy stored within this remote dc power source. Other Power source means including wind turbine or auxiliary generator can substitute for the solar panel.

A solid grounding means 154, such as a ground rod, provides a return path for the modulated communication signal and power source. This power source 156 is useful when the rectifier 10 cannot provide adequate power for signaling. This power source 156 can be bypassed by command along wired connection 160 from the remote control unit 60. Additionally, the storage batteries in the Power Source have connections 162 to the Remote Control Unit 60.

Since all stations are capable of maintaining the correct time, a shared system of time management allows each station to communicate at a given time slot. As an example, the base station listens at the top of the hour for a signal from a first remote station, and a minute later from a second remote station, etc. This is a normal form of time division multiplexing. Under alarm situations a remote station will supercede this protocol and send an immediate communication to the base station. Under most circumstances the communication bursts will be few and far between, preserving power requirements. The individual MCUs are capable of maintaining a clock and calendar time-base within a few seconds per month with very low power requirements. Periodic COT and base station commands to the remote control units can synchronize these clocks. Modern MCUs include power management circuitry to shut down unused internal sections while remaining vigilant to changes on input lines and timed wake-ups.

Structures having electrically isolated sections by means of insulated non-conductive spacers, pipe sections or flanges can be bridged with a communication signal isolation capacitor connected across the insulated section. In this manner the AC varying communication signal voltage bridges the insulated section while the direct current is blocked.

The modulator can be place in the circuit between the ground and the rectifier positive.

Similarly, the modulator can be placed between a buried sacrificial anode usually made of active metals such as aluminum or magnesium, and the pipe, where the anode to pipe metallic couple is the source of the protective current.

The modulator can be used to attenuate the voltage to the pipe, much like adjustable taps on the rectifier assembly transformer. The modulator can act as a series linear voltage regulator, raising or lowering the voltage to another level. Or the modulator can behave as a switching regulator, by pulse width modulation PWM to lower the effective DC voltage applied to the structure. The duty cycle of the PWM determines the effective DC voltage level on the structure. In this instance the modulator is supplied with two superimposed modulating signals. The first is of a high enough frequency to be smoothed to an effective DC level by the load capacitance inherent in the pipe structure or by a series inductance and parallel capacitance. A lower frequency in the approximately 2 kHz to 20 kHz range for signaling purposes is impressed over the higher frequency.

What is claimed:

1. A monitoring and control apparatus comprising at least one remote pipeline valve monitor [RPVM] connected by wire to a remote pipe structure;
at least one local communication relay station [LCRS] connected by wire to a local pipe structure;
at least one distant communication modulator [DCM] connected by wire between the at least one remote pipeline valve monitor [RPVM] and the remote pipe structure;
at least one local communication modulator [LCM] connected by wire between the local communication relay station [LCRS]and the local pipeline structure;
the at least one remote pipeline valve monitor and the at least one local communication relay station in direct communication by electrical communication signal using the metal pipeline structure as a conductor.

2. A monitoring and control apparatus as cited in claim 1, comprising at least one radio frequency transceiver communication device connected to the at least one local communication relay station.

3. A monitoring and control apparatus as cited in claim 1, comprising at least one radio frequency transceiver communication device connected to the at least one remote pipeline valve monitor RVCM.

4. A monitoring and control apparatus as cited in claim 1 comprising at least one pressure monitor connected to the at least one remote pipeline valve monitor RPVM.

5. A monitoring and control apparatus as cited in claim 1 comprising at least one valve position monitor connected to the at least one remote pipeline valve monitor RPVM.

6. A monitoring and control apparatus as cited in claim 1 comprising at least one valve position limit switch connected to the at least one remote pipeline valve monitor RPVM.

7. A monitoring and control apparatus comprising at least one remote corrosion protection monitor [RCPM] connected by wire to a remote metal structure;
at least one local communication relay station connected by wire to a local metal structure;
at least one remote communication modulator connected by wire between the at least one remote corrosion protection monitor RCPM and the remote metal structure;
at least one local communication modulator connected by wire between the local communication relay station and the local metal structure;
the at least one remote corrosion protection monitor RCPM and the at least one local communication relay station in direct communication by electrical communication signal using the metal structure as a conductor.

8. A monitoring and control apparatus as cited in claim 7, comprising at least one radio frequency transceiver communication device connected to the at least one local communication relay station.

9. A monitoring and control apparatus as cited in claim 7, comprising at least one radio frequency transceiver communication device connected to the at least one remote corrosion protection monitor RCPM.

10. A monitoring and control apparatus as in claim 7 comprising at least one electrical parameter reading circuit having at least one DC voltage measurement range.

11. A monitoring and control apparatus as cited in claim 7 comprising at least one electrical parameter reading circuit having at least one AC voltage measuring range.

12. A monitoring and control apparatus as cited in claim 7 comprising at least one electrical parameter reading circuit having at least DC current measuring range.

13. A monitoring and control apparatus as cited in claim 7 comprising at least one electrical parameter reading circuit having at least one AC current measuring range.

14. A network apparatus comprising the at least one remote control valve monitor RCVM and the at least one remote corrosion protection monitor RCPM in communication with at least one local communication relay station.

15. A network apparatus as cited in claim 14 comprising the at least one remote control valve monitor RCVM and the at least one remote corrosion protection monitor RCPM in communication with the at least one local communication relay station;
and at least one secure private network to maintain secure and private communication; and,
at least one public network bridge connecting the at least one secure private network in bidirectional communication with a central office terminal [COT].

16. A network apparatus as cited in claim 14 comprising an at least one database prioritizing a set of actions in response to a detected alarm by the at least one remote corrosion protection monitor [RCPM] and the at least one remote pipeline valve monitor [RPVM].

17. A network apparatus as cited in claim 15 comprising the at least one database prioritizing a set of actions in response to a detected alarm in the central office terminal [COT] to alert the proper authorities.

18. A monitoring and control apparatus as cited in claim 7 comprising the metal structure selected from at least one of a group of pipeline, pipe, steel buildings, bridges, steel rod reinforced concrete structures, metal tanks, and the like, to be protected from corrosion.

19. A monitoring and control apparatus as cited in claim 7 comprising the local modulator connected between a buried sacrificial anode usually made of active metals such as aluminum or magnesium, and the metal structure, where the anode to metal structure metallic couple is the source of the protective current.

20. A monitoring and control apparatus as cited in claim 7 comprising the local modulator used to attenuate the voltage to the metal structure, thereby raising or lowering the voltage on the metal structure by remote command.
